(19) United States
(12) Patent Application Publication
(10) Pub. No.: US 2016/0242976 A1
(43) Pub. Date: Aug. 25, 2016

(54) ELASTIC WHEELCHAIR HAND RIM COVER AND METHODS OF USE

(71) Applicant: INTELLIWHEELS, INC., Champaign, IL (US)

(72) Inventors: Scott C. Daigle, Champaign, IL (US); Marissa SIERO, Champaign, IL (US); Josh GEORGE, Champaign, IL (US); Steven PICK, Urbana, IL (US)

(21) Appl. No.: 15/047,164

(22) Filed: Feb. 18, 2016

Related U.S. Application Data
(60) Provisional application No. 62/118,278, filed on Feb. 19, 2015.

(51) Int. Cl. A61G 5/02

(52) U.S. Cl. CPC A61G 5/028; A61G 5/022

(57) ABSTRACT

Soft and stretchable wheelchair hand rim covers are disclosed, which fit onto any wheelchair hand rim to improve the ergonomics, power transfer, and comfort of the way that the wheelchair user interacts with the hand rim of the wheelchair.

### CROSS-REFERENCE TO RELATED APPLICATIONS

The present application claims priority to U.S. Provisional Application Ser. No. 62/118,278, filed Feb. 19, 2015, which is herein incorporated by reference in its entirety.

### BACKGROUND

Often times mobility impairments such as: quadriplegia, cerebral palsy, arthritis, multiple sclerosis, and stroke can impact a person's ability to use their lower extremities as well as their upper extremities. While a wheelchair can be an effective solution to improve mobility for a person with limited lower extremity function, the effectiveness of self-propelling a manual wheelchair can be reduced if a person does not have adequate hand dexterity. Neurological, osteopathic, and or neuro-muscular limitations of the upper extremities, especially of the hands and forearms, are common in cases of spinal cord injury and can make self-propelling a manual wheelchair difficult. Such individuals as well as older or geriatric wheelchair users may find traditional manual wheelchairs difficult to propel due to their decreased ability to grip and push manual wheelchair's smooth plastic or metal hand rims.

To address this problem, the wheelchair industry currently offers rubber coated hand rims as a $300 dollar optional extra on the wheelchair. The rubber coating tends to dry out, crack, deteriorate and become sharp in the user's hands after one year, but it cannot easily be replaced as it involves a long process of removing the tire with special tools that most users do not possess.

In other solutions, as exemplified by U.S. Patent Application Publication 2001/0007389 filed by Carol Frauwirth, a cover uses an adhesive to permanently attach the cover to the hand rims. As a result, the covers are difficult to replace.

Another solution, as exemplified by U.S. Pat. No. 7,040,642 issued to Douglas B. Lowry, describes a substantially ring-shaped sleeve that fits onto a hand rim through an annular gap into a hollow interior. However, the hand rim must align with the diameter of the gap. In other words, the sleeve corresponds to one hand rim diameter. As such, each hand rim diameter must have a corresponding sleeve.

In view of the existing hand rim covers, sleeves and coatings that provide comfort and grip for wheelchair users, there exists a need for a one size fits all hand rim cover that is comfortable, secure, easily installed and easily removed.

### SUMMARY OF THE INVENTION

A wheelchair hand rim cover is disclosed and generally comprises an elastic loop having a relaxed diameter and cross sectional area, wherein the product of the cross sectional area and modulus of elasticity ranges from about 70 pounds to 180 pounds; a gap extending circumferentially along the elastic loop and corresponding to the hand rim; a first edge and second edge separated by the gap; a hollow interior bounded by an interior wall of the elastic loop; and an exterior surface.

In another embodiment, a wheelchair hand rim cover is disclosed and generally comprises a hand rim including at least one groove disposed around a circumferential ring of the hand rim; the at least one groove includes a longitudinal axis running along the entire circumference of the hand rim; and the at least one groove complimentary fits with the groove of the hand rim cover as to keep the hand rim cover from being axially pushed from the longitudinal axis of the at least one groove.

The methods, systems, and apparatuses are set forth in part in the description which follows, and in part will be obvious from the description, or can be learned by practice of the methods, apparatuses, and systems. The advantages of the methods, apparatuses, and systems will be realized and attained by means of the elements and combinations particularly pointed out in the appended claims. It is to be understood that both the foregoing general description and the following detailed description are exemplary and explanatory only and are not restrictive of the methods, apparatuses, and systems, as claimed.

### BRIEF DESCRIPTION OF THE DRAWINGS

In the accompanying figures, like elements are identified by like reference numerals among the several preferred embodiments of the present invention.

FIGS. 1A and 1B illustrate the relaxed and stretched diameter of one embodiment of the hand rim cover.

FIG. 2 is a cross-sectional view along A-A of one embodiment of the hand rim cover applied to a hand rim.

FIG. 3 illustrates alternative cross sectional geometries of embodiments of the hand rim cover.

FIGS. 4A and 4B illustrate an embodiment of textured features disposed on the outer surface of the hand rim cover.

FIGS. 5A and 5B illustrate an embodiment of the first edge that has a plurality of mounting recesses and further illustrate various number and positions of mounting points the mounting recesses can accommodate.

FIGS. 6A through 6C illustrate on procedure for applying an embodiment of the hand rim cover to a wheelchair hand rim.

FIG. 7A is a perspective view of an alternative embodiment of the hand rim; FIG. 7B is a cross-sectional view of the hand rim coupled with an alternative embodiment of the hand rim cover.

FIGS. 8A-8C are cross-sectional view of alternative embodiments of the hand rim and the hand rim cover.

FIG. 9 is a perspective of alternative embodiments of the hand rim cover.

### DETAILED DESCRIPTION OF THE INVENTION

The foregoing and other features and advantages of the invention are apparent from the following detailed description of exemplary embodiments, read in conjunction with the accompanying drawings. The detailed description and drawings are merely illustrative of the invention rather than limiting, the scope of the invention being defined by the appended claims and equivalents thereof.

Embodiments of the invention will now be described with reference to the Figures, wherein like numerals reflect like elements throughout. The terminology used in the description presented herein is not intended to be interpreted in any limited or restrictive way, simply because it is being utilized in conjunction with detailed description of certain specific embodiments of the invention. Furthermore, embodiments of the invention may include several novel features, no single one of which is solely responsible for its desirable attributes or which is essential to practicing the invention described herein. The words proximal and distal are applied herein to denote specific ends of components of the instrument described herein. A proximal end refers to the end of an instrument nearer to an operator of the instrument when the instrument is being used. A distal end refers to the end of a component further from the operator and extending towards the surgical area of a patient and/or the implant.

The use of the terms “a” and “an” and “the” and similar referents in the context of describing the invention are to be construed to cover both the singular and the plural, unless otherwise indicated herein or clearly contradicted by context. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Recitation of ranges of values herein are merely intended to serve as a shorthand method of referring individually to each separate value falling within the range, unless otherwise indicated herein, and each separate value is incorporated into the specification as if it were individually recited herein. The word “about,” when accompanying a numerical value, is to be construed as indicating a deviation of up to and inclusive of 10% from the stated numerical value. The use of any and all examples, or exemplary language (“e.g.” or “such as”) provided herein, is intended merely to better illuminate the invention and does not pose a limitation on the scope of the invention unless otherwise claimed. No language in the specification should be construed as indicating any nonclaimed element as essential to the practice of the invention.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

In one embodiment, the hand rim cover is an elastic loop that has the property to stretch from a rested diameter to the uncoated rim diameter with no tools. Furthermore, the exemplary embodiment also has a coefficient of static or kinetic friction between the material and the hand rim to prevent slipping during use with only the tension of the material. As such, the same goal is accomplished as permanently coated hand rims, but the exemplary embodiment can be reversibly installed and replaced with no tools and can fit tightly on a wide range of hand rim diameters without requiring tools. One embodiment is made from a significantly softer material than traditional coated hand rims, and provides a significantly more comfortable feel when compared to uncoated and coated hand rims.

In one embodiment, the cover is molded instead of extruded to feature textured and raised surfaces and logos under the hand to provide a better grip for the user. The texture is confined only to the top surface of the grip, and no texture is provided on the outside surface of the hand rim which is commonly used for braking and slowing the wheelchair. Texture there has been found to be disruptive and uncomfortable during the braking process but helpful on the top of the rim when propelling. In the exemplary embodiment, hand rim cover jackets the top and sides of the hand rim. The bottom is left completely bare for smooth braking.

In another embodiment, the hand rim cover is an elastic loop having a relaxed diameter and cross sectional area. The elasticity of the exemplary embodiment is characterized by the product of the material's modulus of elasticity and cross sectional area ranging from about 70 pounds to 180 pounds. The exemplary embodiment has a gap extending circumferentially along the elastic loop that separates a first edge from a second edge. The gap corresponds to the hand rim such that the hand rim can enter through the space between the first and second edge to a hollow interior of the elastic loop through the gap.

In one embodiment, the hand rim cover is an elastic loop with a relaxed diameter ranging from about 17 inches to about 20 inches. In the exemplary embodiment, the elastic loop is able to stretch from the relaxed diameter to fit wheelchairs having nominal wheel diameters ranging from 24 to 26 inches, or hand rims with outside diameters ranging from 20.0 to 22.8 inches.

In another embodiment, the hand rim cover is an elastic loop with a relaxed diameter ranging from about 13 inches to about 18 inches. In the exemplary embodiment, the elastic loop is able to stretch from the relaxed diameter to accommodate pediatric sized wheelchair wheels.

In one embodiment, the cross sectional area of the hand rim cover has a center line defined by the boundary where substantially equal amounts of material comprise each side of the line.

In another embodiment, the hand rim cover has an apex circumferentially disposed on the outer surface of the elastic loop.

In another embodiment, the apex is disposed off the center line towards the wheel.

In one embodiment, the apex has a thickness defined between the interior wall and the highest point of the apex ranging from about 0.15 inches to about 0.45 inches.

In one embodiment, the hand rim cover has a Type A Shore Durometer hardness ranging from about 30 Shore to about 70 Shore.

In another embodiment, the hand rim cover has a surface roughness of at least about 30 Ra micro-inches.

In one embodiment, the hand rim cover has a coefficient of static or kinetic friction between the interior wall and the hand rim of at least about 0.01 and about 0.39.

In one embodiment, the first edge is a series of mount recesses that are evenly distributed circumferentially.

In one embodiment there are 72 mount recesses equally spaced around the circle.

In one embodiment, the hand rim cover is an elastic loop that has a stretched diameter. The upper limit of the stretched diameter of the exemplary embodiment is greater than about 125% of the relaxed diameter.

In one embodiment the hand rim cover has significantly more material is disposed on top of the hand rim than the side of the hand rim to provide greater comfort when gripped by the user.

In another embodiment the hand rim cover has textured features disposed on the outer surface of the hand rim cover to provide improved grip. In an exemplary embodiment, the textured features are disposed only on the top section of the outer surface to provide a smooth braking surface on the side sections of the hand rim cover.

Generally speaking, a hand rim for a 24 inch wheelchair wheel is usually in the range of 19.5-21.5 inches in diameter. 26 inch wheels have hand rims 21.5-22.5 inches in diameter. Size is stated relative to the wheel size in the wheelchair. As such, embodiments described herein fit on a hand rim for a stated wheel diameter, not for a specific hand rim size. This is consistent with industry practice as manufacturers and retailers only list the diameter of the wheel to which the hand rim attaches.

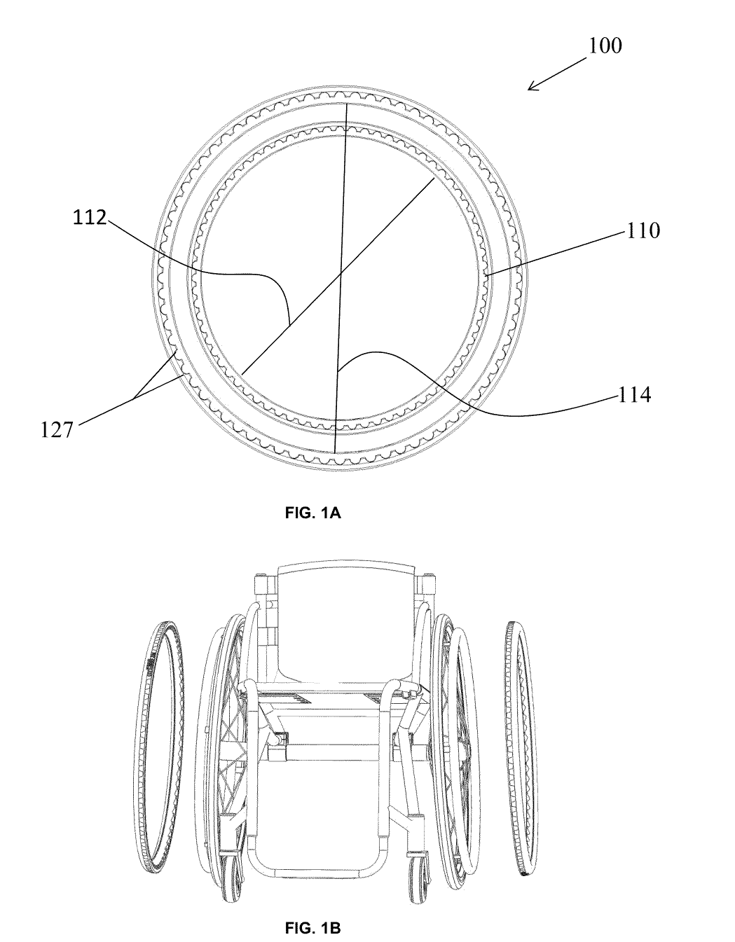

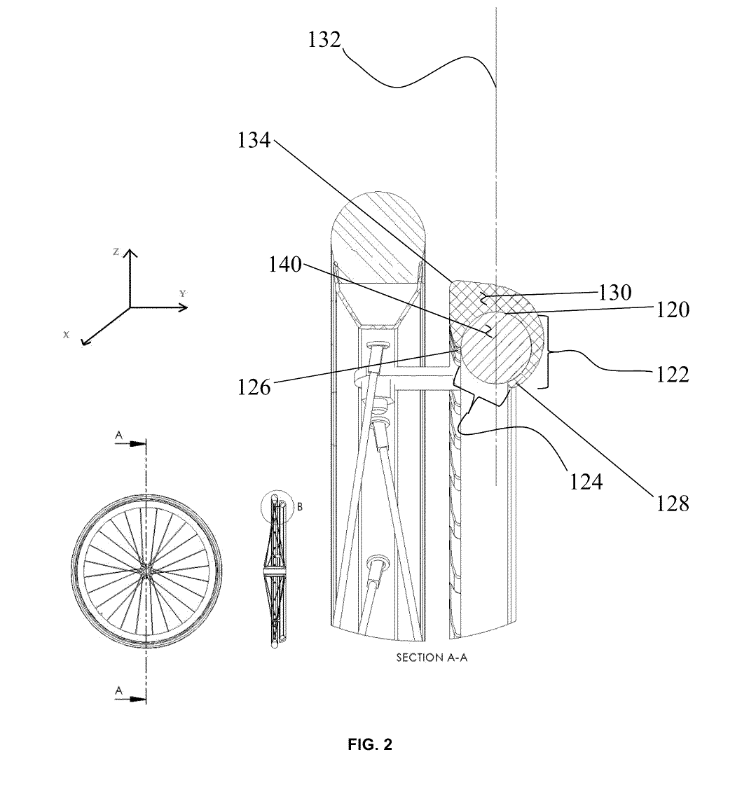

In an embodiment as shown in FIG. 1A, the hand rim cover 100 is an elastic loop 110, which has a relaxed diameter 112 and a stretched diameter 114. In an exemplary embodiment, the stretched diameter 114 accommodates various hand rims corresponding to wheelchair wheel sizes. An exemplary embodiment, as shown in FIG. 1B, illustrates elastic loop 110 expanded to a stretched diameter 112 to accommodate the diameter of the hand rim. The elasticity of the elastic loop 110 provides a normal force on the hand rim surface such that the coefficient of static or kinetic friction between the hand rim 140 and interior wall 120, as shown in FIG. 2, provide a frictional force to prevent the elastic loop from slipping in use. In one embodiment, the elasticity is characterized by the product of the modulus of elasticity and cross sectional area of the loop. In an exemplary embodiment, the product of the modulus of elasticity and cross sectional area of the loop ranges from about 50 pounds to about 200 pounds. A more preferred range is from about 70 pounds to about 180 pounds. In the exemplary embodiment, the coefficient of static or kinetic friction is at least about 0.3. A more preferred limit is at least about 0.39, alternatively between about 0.01 and 0.04. In one embodiment the stretched diameter 114 has an upper limit of stretching to a diameter of about 130% the relaxed diameter 112. In a preferred embodiment, the stretched diameter 114 has an upper limit of stretching to a diameter of about 125% the relaxed diameter 112. A more preferred upper limit of stretching is about 123% the relaxed diameter.

Embodiments using different hand rim cover 100 materials having material properties resulting in various elasticity and various coefficients of static or kinetic friction with various hand rim 140 materials are fully contemplated as long as the coefficient of static or kinetic friction and the product of the cross sectional area with the modulus of elasticity are within acceptable ranges preventing slippage during use.

In one embodiment, the relaxed diameter 112 ranges from about 17 inches to about 20 inches, wherein any loop diameter within the range can stretch to accommodate wheelchair wheel sizes between 24 and 26 inches. In another embodiment, the relaxed diameter 112 ranges from about 13 inches to 18 inches to accommodate pediatric size wheelchair wheel diameters 20 and 22 inches, wherein any loop diameter within the range can stretch to fit the pediatric size wheelchair wheel diameters.

In one embodiment, the hand rim cover 100 is an elastic loop 110 having a hardness that is comfortable to touch and grip. In an exemplary embodiment, the hardness of elastic loop 110 is measured by a Shore durometer type A scale and has a durometer ranging from about 25 Shore A to about 75 Shore A. A more preferred hardness of elastic loop 110 ranges from about 30 Shore A to about 70 Shore A.

In an embodiment, the hand rim cover 100 is an elastic loop 110 having a surface roughness suitable to hide the feeling of dirt, dust and grit. In one embodiment, the surface roughness has an arithmetic average roughness (Rₐ) at least about 30 μ-inches. A preferred surface roughness is at least about 32 μ-inches.

To provide secure and uniform circumferential contact between the outer surface of hand rim 140 and substantially the entire surface of interior wall 120, as shown in FIG. 2, one embodiment of the hand rim cover 100, is an elastic loop 110 that includes a hollow interior 122 having a dimension complementing the outer surface of hand rim 140. In an exemplary embodiment as shown in FIG. 2, the hand rim 140 enters the hollow interior 122 through a gap 124 that is circumferentially disposed along the elastic loop 110. In the exemplary embodiment, the gap 124 provides separation between a first edge 126 and second edge 128 such that the space provided by the gap 124 limits coverage to the top and side portions of hand rim 140. In this embodiment, the bottom of hand rim 140 is left uncovered for smooth braking. In another embodiment not shown, the space provided by gap 124 results in the second edge 128 extending to cover the bottom portion of hand rim 140.

As shown in FIG. 2, the cross sectional view of hand rim cover 100 has a center line 132. In one embodiment, as shown in FIG. 2, the center line 132 is defined as the edge of a plane that divides the cross section of hand rim cover 100 into substantially equal amounts of material on each side. The center line 132 as shown in FIG. 2, although asymmetric, represents that the amount of material on the left and right side of center line 132 is equal. In one embodiment, the hand rim cover 100 is an elastic loop wherein center line 132 divides elastic material of the elastic loop 110 into equal portions on each side of the center line 132. In other embodiments not shown, it is fully contemplated that the center line 132 is an axis of symmetry. In the embodiment as shown in FIG. 2, center line 132 is collinear with the z-axis of hand rim 140.

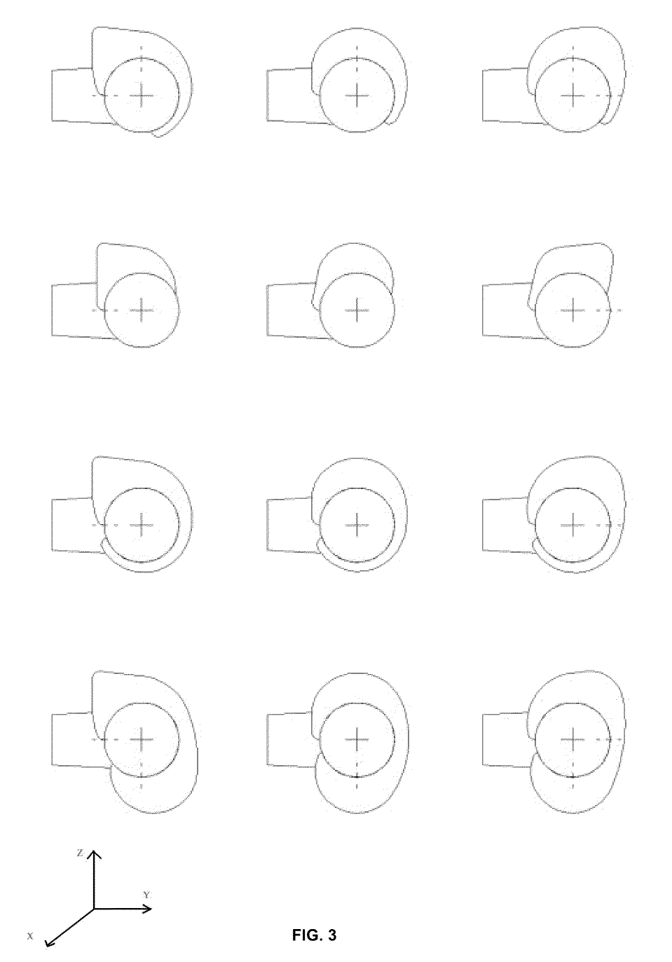

In one embodiment, as shown in FIG. 2, the hand rim cover 100 includes an apex 134 circumferentially disposed on the outer surface of the hand rim cover 100. The apex 134 may be disposed such that the peak of the apex 134 is aligned with the center line 132. In an exemplary embodiment, as shown in FIG. 2, the peak of the apex 134 is off set toward the wheelchair wheel. The offset toward the wheelchair wheel functions to prevent the hand of the user from contacting any sharp edges that may result from the parting line during molding of the hand rim cover 100. The apex 134 has a thickness disposed between the peak of apex 134 to the interior wall 120. In one embodiment the thickness ranges from about 0.1 inches to about 1 inch. A more preferred thickness ranges from about 0.1 inches to 0.5 inches. The most preferred thickness ranges from about 0.15 inches to about 0.45 inches. As shown in FIG. 2, significantly more material comprising the hand rim cover 100 is on the top of the hand rim to provide a comfortable cushion under the hand of the user. FIG. 3 depicts various embodiments of the hand rim cover 100 having a several different cross-sectional geometries. While the top left drawing is the most preferred embodiment, the other cross sections have pros and cons associated with them for users with different injury types and, therefore, different styles of grip. The profiles in the center column all have the thickest section right on the top which is good for comfort, but most manufacturing processes will leave a small ridge directly under the most sensitive portions of the hand. The profiles on the right column have added cushion directly under the top right quarter which is great for users with quadriplegia, but not as comfortable for other injury types. The cross sections at the bottom of the page feature a longer cross section top to bottom which fits a wide variety of hands and tends to be more comfortable, but they use quite a bit more material which makes them expensive to manufacture. Some of the grip profiles have coverage over more of the hand rim than others which can be good for enhanced grip but detrimental during braking. All wheelchair users have a slightly different style of grip when using a wheelchair, and selected to optimize balance of comfort, manufacturability, power, and braking.

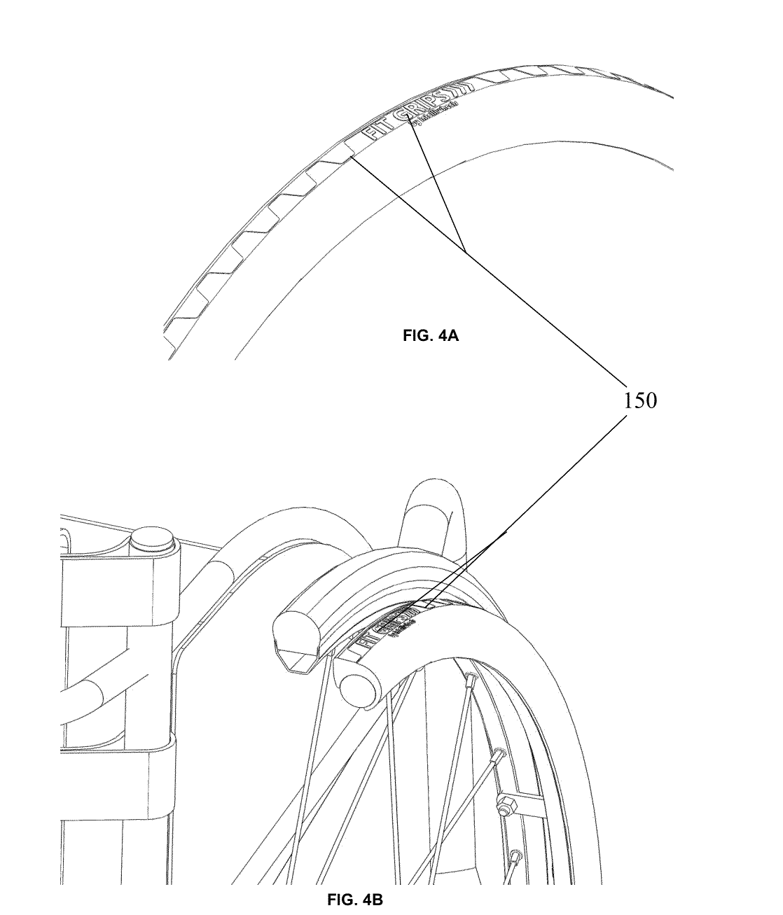

In one embodiment, as shown in FIGS. 4A and 4B, textured features 150 are disposed on the outside surface of the hand rim cover 100. The textured features 150 function to provide greater grip for the user. In an exemplary embodiment, the textured features 150 are confined to only the top surface of the hand rim cover 100. The side portion of hand rim cover 100 is commonly used by an individual for braking and slowing the wheelchair by hand. As such, disposition of the textured features 150 to the top portion of the hand rim cover 100 functions to provides a smooth comfortable surface for braking. Textured features 150 can include any geometry and/or includes logos comprised of any symbols and/or text.

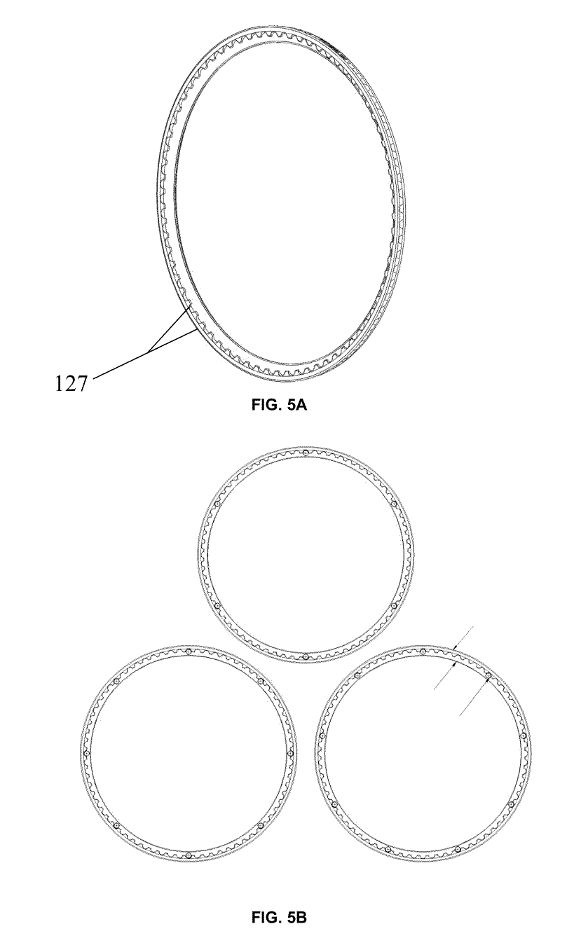

As shown in FIGS. 1 and 5A, one embodiment of the first edge 126 of hand rim 100 has a plurality of mounting recesses 127. In one embodiment, as shown in FIGS. 5B, the mounting recesses 127 correspond to positions, referred to herein as mounting points, where the hand rim 140 is mounted to the wheelchair wheel. The mounting recesses 127 function to accommodate the mounting points to further secure the hand rim cover 100 and prevent slippage during use in addition to frictional forces. In one embodiment, the mounting recesses 127 are evenly distributed circumferentially along the first edge 126. In an exemplary embodiment, the disposition of evenly distributed mounting recesses 127 accommodates 6, 8 or 9 mounting points equally spaced around the circle. In one embodiment, the first edge 126 has 72 evenly distributed mounting recesses 127.

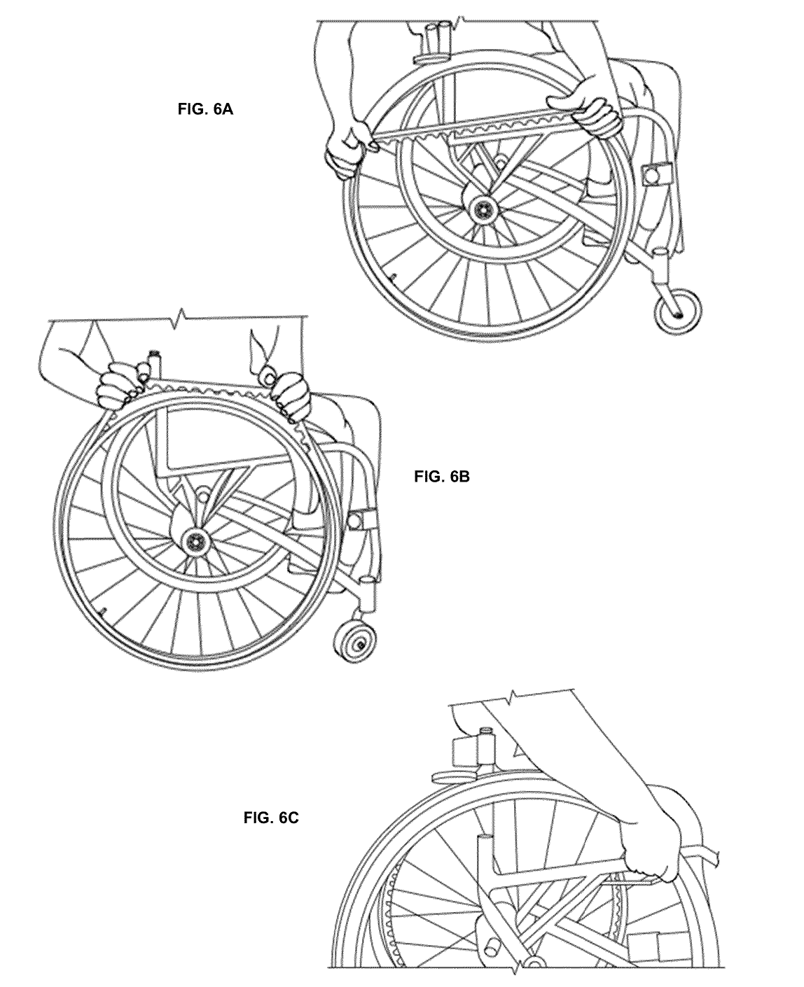

As shown in FIGS. 6A-6C, an exemplary embodiment of the hand rim cover 100 as an elastic loop 110 is applied to a hand rim. As illustrated, initially, the elastic loop 110 covers the hand rim 140 such that the hand rim 140 enters gap 124 in to hollow interior 122 at a section of the hand rim 140. Once secured, the elastic loop 110 is stretched to house the remaining sections such that the mounting points on the hand rim are secured in the mounting recesses 127 of the hand rim until the entirety of the hand rim is covered for use as shown in FIG. 5C.

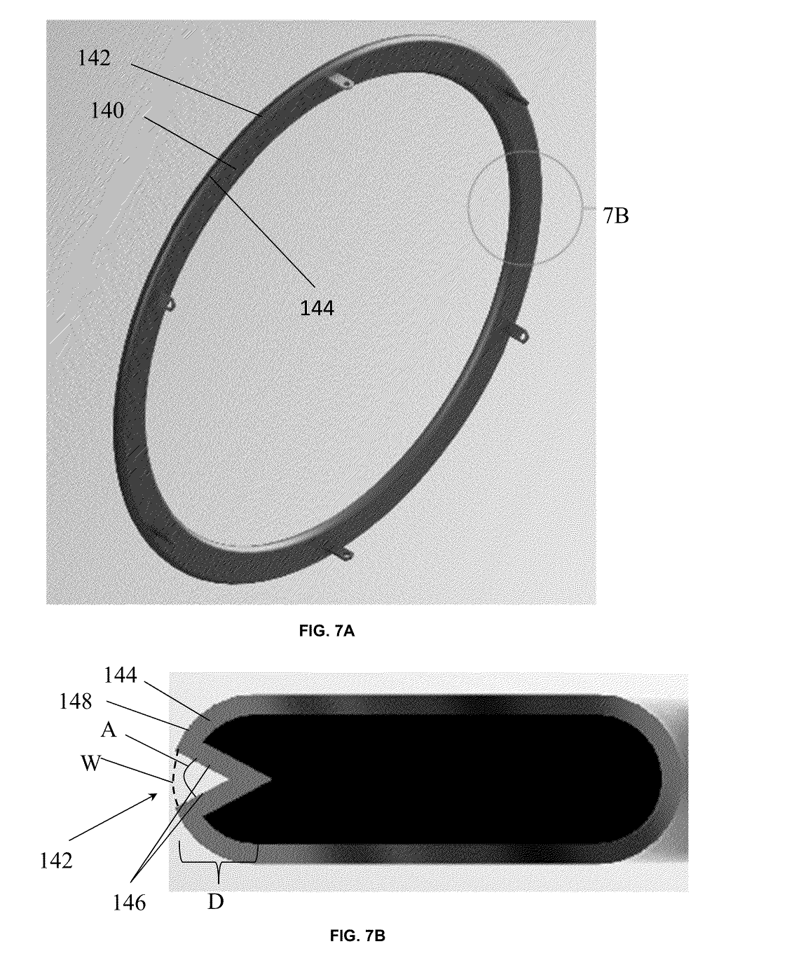

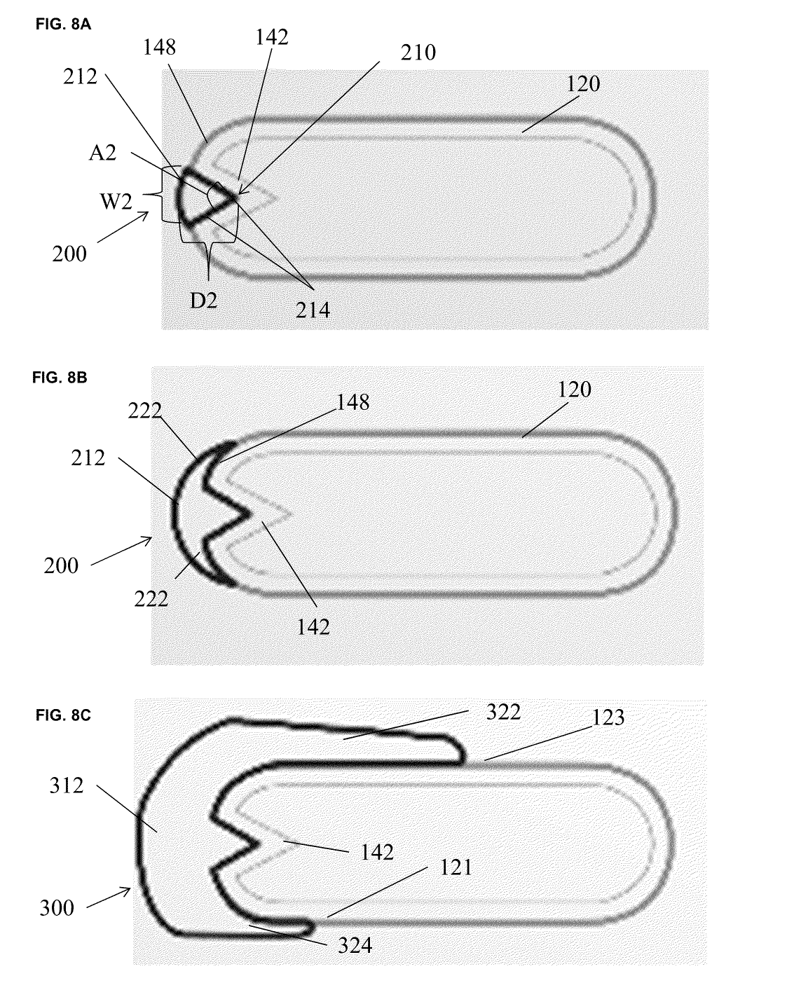

In an alternative embodiment, the hand rim 140, as shown in FIGS. 7A-7B, includes at least one groove 142 disposed around the entire the circumferential ring 144 of the hand rim 140. The at least one groove includes a longitudinal axis running along the entire circumference of the hand rim 140. The at least one groove 142 complimentary fits with the groove of the hand rim cover 200, as shown in FIGS. 8A-8C, as to keep the hand rim cover from rotating or being axially pushed from the longitudinal axis of the at least one groove.

The circumferential ring 144 of the hand rim 140 includes a profile or cross-section disposed with the thickness, as shown in FIG. 7B. The at least one groove 142 is disposed at a depth D into the profile of the circumferential ring 144. The at least one groove 142 includes a cross section or profile that is generally V-shaped. Alternatively, the at least one groove 142 may include alternative cross-sections or profiles such as square shaped, U shaped, trapezoidal shaped, polygonal shaped, rectangular shaped, or keyway shaped. In one embodiment, the depth D may be between 0.1 inches to about 2.0 inches, alternatively, the depth D may be between 0.1 and 0.5 inches. The depth D may be selected based upon type of hand rim cover being used and degree of rotation and pull on the hand rim cover. For example, a greater depth D may be selected for a thicker hand rim cover or a greater degree of rotation and pull of the hand rim cover. The at least one groove 142 also includes an angle A formed by at least two wall surfaces 146. The angle A may be between 25 and 75 degrees. The angle A may be selected based upon the degree of rotation and pull on the hand rim cover. For example, a larger angle A may be selected for a thicker hand rim cover or a greater degree of rotation and pull of the hand rim cover.

The wall surface 146 of each groove 142 may be substantially smooth, such as illustrated in FIG. 7B, or wall surface 146 may be jagged, or roughened, as to prevent longitudinal movement of the hand rim cover 200 during external pressure or force. The wall surface 146 could also be provided with at least one axial indentation if desired, and a complementary axial protrusion for the hand rim cover could be provided as to prevent longitudinal movement of the hand rim cover 200 during external pressure or force.

As shown in FIG. 7B, the groove 142 includes a width W that traverses an imaginary line from a circumferential surface 148 of the circumferential ring 144. The hand rim cover 200 includes an outer width W2, as shown in FIG. 8A, to sufficiently plug or fill the outer width W of the at least one groove 142 to provide a grip or traction for the user.

As shown in FIG. 8A, the hand rim cover 200 is shown operably coupled to the hand rim 120. The hand rim cover 200 includes at least one protrusion 210 extending around the entire inner circumferential ring of the hand rim cover 200. The at least one protrusion 210 includes an inner wall surface 214 and is complimentary and fits into the at least one groove 142, whereby a user grips the outer circumferential ring 212 when the hand rim cover 200 is engaged with the at least one groove 142 of the hand rim 120. The at least one protrusion 210 includes a cross section or profile that is generally V-shaped. Alternatively, the at least one protrusion 210 may include alternative cross-sections or profiles as to be complimentary to the at least one groove 142, such as square shaped, U shaped, trapezoidal shaped, polygonal shaped, rectangular shaped, or keyway shaped. In one embodiment, the at least one protrusion 210 includes a depth D2, which is complimentary to the depth D of the at least one groove 142, which may be between 0.1 inches to about 0.5 inches; alternatively the depth may be between 0.1 and 2.0 inches. As such, the depth D2 may be selected based upon type of hand rim cover 200 being used and degree of rotation and pull on the hand rim cover. For example, a greater depth D2 may be selected for a thicker hand rim cover or a greater degree of rotation and pull of the hand rim cover. The at least one protrusion 210 also includes an angle A2 which is complimentary to the angle A of the at least one groove 142. In one embodiment, the angle A2 may be between 5 and 60 degrees. The angle A2 may be selected based upon the degree of rotation and pull on the hand rim cover. For example, a larger angle A may be selected for a thicker hand rim cover or a greater degree of rotation and pull of the hand rim cover.

In one embodiment, the hand rim cover 200 may include a low profile when engaged with the hand rim 140, as shown in FIG. 8A. The outer width W2 of the hand rim cover 200 sufficiently traverses and fills the width W of the at least one groove 142. The outer width W2 traverses and completes the circumferential surface 148 at the outer width W as to allow for a low profile of the hand rim cover 200. In one embodiment, the at least one protrusion includes at least two inner wall surfaces 214 that substantially abut and engage the wall surfaces 146 of the at least one groove 142. In one embodiment, the inner wall surfaces 214 may include a coefficient of static or kinetic friction between the wall surface 146 of the groove 142 to prevent slipping during use with only the tension of the material, as previously described. Alternatively, a non-permanent glue may be used to seal the wall surfaces 214 of the hand rim cover 200 to the wall surface 146 of each groove 142.

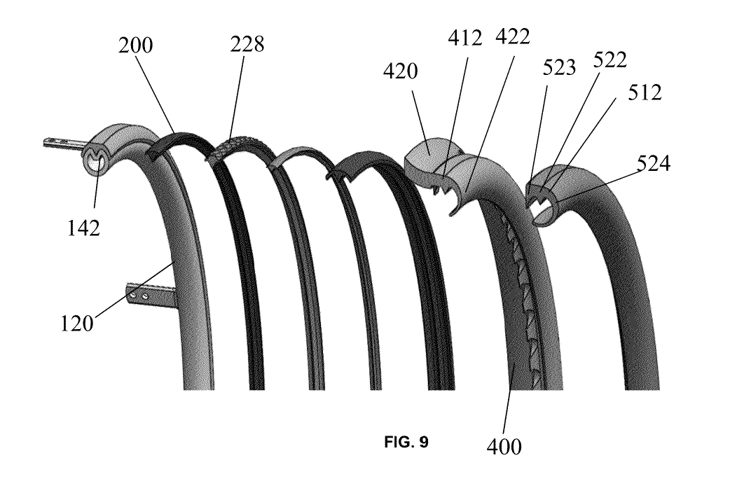

As shown in FIG. 8B, an alternative hand rim cover 300 includes an alternative profile whereby the circumferential ring 212 of the hand rim cover 220 substantially covers the circumferential surface 148 of the hand rim 120. The circumferential ring 212 includes at least two covering portions 222 that cover the circumferential surface 148 on both sides of the at least one groove 142. The circumferential ring 212 includes a substantially curved portion as to match the curvature of the circumferential surface 148. In one embodiment, the circumferential ring 212 includes a textured outer surface 228 for additional gripping capabilities for the user, as shown in FIG. 9. In one embodiment, the two covering portions 222 may include a coefficient of static or kinetic friction with the circumferential surface 148 of the hand rim 120 to prevent slipping during use with only the tension of the material, as previously described.

As shown in FIG. 8C, an alternative hand rim cover 300 includes an alternative profile whereby the circumferential ring 312 includes a first covering portion 322 and a second covering portion 324. The second covering portion 324 extends along a second side 123 of the hand rim 120, and the first covering portion 322 extends along a first side 121 of the hand rim 120. The second covering portion 324 and the first covering portion 322 allow for a wider grip area and increased surface area, so a user may control the hand rim cover 300 with almost any part of the hand.

As shown in FIG. 9, the hand rim 120 with the groove 142 showing alternative profiles or cross-sections of the hand rim covers that can be interchanged. In one embodiment, the hand rim cover 400 may include a winged portion 420 extending from the circumferential ring 412. The hand rim cover 400 may include only a first covering portion 422 extending around at least half of the circumference of the hand rim. In one embodiment, the hand rim cover 500 includes a circumferential ring 512 including a first covering portion 522 with a substantially flat side 523. The hand rim cover 500 includes a second covering portion 524 extending around more than half of the circumference of the hand rim 120.

While the invention has been described in connection with various embodiments, it will be understood that the invention is capable of further modifications. This application is intended to cover any variations, uses or adaptations of the invention following, in general, the principles of the invention, and including such departures from the present disclosure as, within the known and customary practice within the art to which the invention pertains.

What is claimed is:

1. A wheelchair hand rim cover comprising:
an elastic loop having a relaxed diameter and cross sectional area, wherein the product of the cross sectional area and modulus of elasticity ranges from about 70 pounds to 180 pounds;
a gap extending circumferentially along the elastic loop and corresponding to the hand rim;
a first edge and second edge separated by the gap;
a hollow interior bounded by an interior wall of the elastic loop; and
an exterior surface.

2. The hand rim cover of claim 1, wherein the relaxed diameter ranges from about 13 inches to about 20 inches; and the cross sectional area of the hand rim cover further comprises a center line.

3. The hand rim cover of claim 2, wherein substantially equal amounts of material comprise each side of the center line.

4. The hand rim cover of claim 2, further comprising an apex circumferentially disposed on the outer surface.

5. The hand rim cover of claim 4, wherein the apex is disposed off the center line; and
wherein the apex comprises a thickness ranging from about 0.15 inches to about 0.45 inches.

6. The hand rim cover of claim 1, wherein significantly more material is on the top of the hand rim; and wherein the elastic loop has a hardness ranging from about 30 Shore A to about 70 Shore A.

6. and rim cover of claim 6, wherein the elastic loop has a surface roughness of at least about 30 Ra micro-inches; and wherein substantially continuous circumferential contact between the interior wall and the hand rim has a coefficient of static or kinetic friction of at least 0.39.

8. The hand rim cover of claim 7, further comprising a stretched diameter, wherein the stretched diameter is about 125% the diameter of the relaxed diameter; and wherein the first edge is comprised of mount recesses.

9. The hand rim cover of claim 8, further comprising textured features disposed on the outer surface of the hand rim cover, wherein the textured features are disposed only on the top section of the outer surface.

10. A wheelchair hand rim cover comprising: a hand rim including at least one groove disposed around a circumferential ring of the hand rim; the at least one groove includes a longitudinal axis running along the entire circumference of the hand rim; and the at least one groove complimentary fits with the groove of the hand rim cover as to keep the hand rim cover from being axially pushed from the longitudinal axis of the at least one groove.

11. The wheelchair hand rim cover of claim 10, wherein the circumferential ring of the hand rim includes a profile disposed with the thickness of the circumferential ring; the at least one groove is disposed at a depth D into the profile of the circumferential ring; the at least one groove includes a profile that is selected from a group consisting of generally V-shaped, square shaped, U shaped, trapezoidal shaped, polygonal shaped, rectangular shaped, and keyed shaped.

12. The wheelchair hand rim cover of claim 11, wherein the depth D is between 0.1 inches to about 2.0 inches; the at least one groove includes at least two wall surfaces forming an angle A; wherein the angle A may be between 25 and 75 degrees.

13. The wheelchair hand rim cover of claim 12, the at least one groove includes a width W that traverses an imaginary line from a circumferential surface of the circumferential ring 144; the hand rim cover includes an outer width W2 to fill the outer width W of the at least one groove to provide a traction for the user.

14. The wheelchair hand rim cover of claim 13, wherein the hand rim cover is operably coupled to the hand rim; the hand rim cover including at least one protrusion extending around an inner circumferential ring of the hand rim cover; the at least one protrusion includes an inner wall surface and complimentary fits into the at least one groove, whereby a user grips the outer circumferential ring when the hand rim cover is engaged with the at least one groove of the hand rim.

15. The wheelchair hand rim cover of claim 14, wherein the at least one protrusion includes a profile that is selected from a group consisting of: V-shaped, square shaped, U shaped, trapezoidal shaped, polygonal shaped, rectangular shaped, and keyed shaped.

16. The wheelchair hand rim cover of claim 15 wherein the at least one protrusion includes a depth D2 that is complimentary to the depth D of the at least one groove; the depth D2 may be between 0.1 inches to about 0.5 inches; the at least one protrusion includes an angle A2 which is complimentary to the angle A of the at least one groove; and the angle A2 may be between 5 and 60 degrees.

17. The wheelchair hand rim cover of claim 16, the hand rim cover includes a outer width W2 to sufficiently fills the width W of the at least one groove; wherein the outer width W2 traverses and completes the circumferential surface at the outer width W as to allow for a low profile of the hand rim cover; the hand rim cover includes at two inner wall surfaces that substantially abut and engage the wall surfaces of the at least one groove; and the two inner wall surfaces 214 include a coefficient of static or kinetic friction between the wall surface of the at least one groove to prevent slipping during use with only the tension of the material. Alternatively, a non-permanent glue may be used to seal the wall surfaces 214 of the hand rim cover 200 to the wall surface 146 of each groove 142.

18. The wheelchair hand rim cover of claim 17, wherein the circumferential ring of the hand rim cover substantially covers a circumferential surface of the hand rim; the circumferential ring includes at least two covering portions that cover the circumferential surface on both sides of the at least one groove; the circumferential ring includes a substantially curved portion as to match the curvature of the circumferential surface; and the two covering portions may include a coefficient of static or kinetic friction with the circumferential surface of the hand rim to prevent slipping during use with only the tension of the material.

19. The wheelchair hand rim cover of claim 17, the circumferential ring includes a first covering portion and a second covering portion; the second covering portion extends along a second side of the hand rim, and the first covering portion extends along a first side of the hand rim; the second covering portion and the first covering portion allow for an increased surface area from a surface area of the hand rim.

20. The wheelchair hand rim cover of claim 17, the hand rim cover includes a winged portion extending from the circumferential ring; the hand rim cover may include only a first covering portion extending around at least half of the circumference of the hand rim.
